(19) United States
(12) Patent Application Publication
(10) Pub. No.: US 2012/0166666 A1
(43) Pub. Date: Jun. 28, 2012

(54) SUPERVISION OF A COMMUNICATION SESSION COMPRISING SEVERAL FLOWS OVER A DATA NETWORK

(75) Inventors: Jerome Tollet, Paris (FR); Jerome Abela, Colombes (FR)

(73) Assignee: QoSOMOS, Parks (FR)

(21) Appl. No.: 13/394,444

(22) PCT Filed: Sep. 1, 2010
(86) PCT No.: PCT/FR2010/051823

§ 371 Date: Mar. 6, 2012

(30) Foreign Application Priority Data
Sep. 9, 2009 (FR) 0956161

(51) Int. Cl. G06F 15/16; H04L 29/06

(52) U.S. Cl. 709/230

(57) ABSTRACT

The invention relates to a method for supervising a communication session over a data network, said session including a first data flow, referred to as the parent flow, using a first protocol, said parent flow including data suitable for setting up a second data flow, referred to as the child flow, using a second protocol for said session, which includes: searching (13) the parent flow for the data that enable the child flow to be set up; generating (15) and storing (17) a signature, referred to as a parent key, using said data; auditing (19) data flows using the second protocol on the data network; creating (21) a signature for each one of the flows; comparing (23) said signature of each one of the flows with the parent key; and, if the comparison is positive, determining (25) that the data flow in question is the child flow of the session.

The invention relates to a method and a system for supervising a communication session over a data network, said session comprising a first data flow, referred to as the parent flow, using a first protocol, said parent flow comprising data which allow establishing a second data flow, referred to as the child flow, using a second protocol for said session. It also relates to a computer program product for implementing the supervision method.

Current network applications generally use more than one session and protocol to carry out their task.

For example, during a video call generated in a videoconference, an RTP session (Real Time Protocol) will be initiated by a SIP session (Session Initiation Protocol), and the parameters of the RTP session will depend on information exchanged by the SIP session.

Network monitoring devices, such as firewalls for example, use state machines to establish the link between sessions of different protocols.

This solution has the disadvantage of increasing the complexity of these devices, because the behavior of a state machine must be defined for each new network application. In addition, processing the different flows can be resource-intensive, which limits the bandwidth available through these devices, or requires developing expensive machines or limiting the amount of data that is monitored.

It would therefore be advantageous to have a supervision method and system which monitor multi-protocol network applications more efficiently in terms of hardware and implementation resources.

To overcome one or more of the above disadvantages, a method for supervising a communication session over a data network, in which said session comprises a first data flow, referred to as the parent flow, using a first protocol, said parent flow comprising data which allow establishing a second data flow, referred to as the child flow, using a second protocol for this session, comprises:
searching the parent flow for the data that allow establishing the child flow;
generating and storing a signature, referred to as the parent key, using these data;
auditing data flows using the second protocol on the data network;
creating a signature for each of the flows;
comparing the signature of each of the flows to the parent key; and
if the comparison is positive, determining that the corresponding data flow is the child flow of the session.

By defining each flow with an appropriate signature and performing a simple signature comparison, an operation which is fast and simple to do by computer, this method advantageously allows easily grouping the related flows, with no need to define a state machine.

Particular features or advantages of the invention, which may be used alone or in combination, are:
the session comprising a determined plurality of child flows, the data flows are audited until the set of child flows is determined.
the child flow comprising data which allow establishing a third data flow using a third protocol for the session, a signature is generated from these data, and data flows using the third protocol are audited until the data flow corresponding to the session is determined.
the method monitoring a plurality of sessions each comprising a parent flow for which a parent key is generated and stored, for each of the flows using the second protocol, the signature is compared to each of the parent keys to determine whether or not the flow is the child flow of one of the sessions.

One should note that this method advantageously applies to a multitude of parent flows, child flows, and any type of tree structure defining an inheritance between one or more parent flows, one or more child flows with any level of inheritance.

In a second aspect of the invention, a computer program product comprises program code, stored on a computer-readable medium, for carrying out the steps of the above method when said program is executed on a computer.

In a third aspect of the invention, a system for supervising a communication session over a data network, said session comprising a first data flow, referred to as the parent flow, using a first protocol, said parent flow comprising data which allow establishing a second data flow, referred to as the child flow, using a second protocol for the session, comprises:
a first flow analyzer for searching the parent flow for data that allow establishing the child flow;
a first signature generator, for generating a signature, referred to as the parent key, using these data;
memory for storing the signature;
a second flow analyzer for auditing data flows using the second protocol on the data network;
a second signature generator for each of these flows;
a comparator for comparing the signature of each of these flows to the parent key; and
a tagger for tagging the flow corresponding to the signature, if the result of the comparator is positive, as the child flow of the session.

In certain embodiments of the invention, the system comprises at least two devices connected by a data network: the first device including at least the memory, the signature comparator, and the tagger, and the second device including at least the first flow analyzer and the first signature generator and an interface for transmitting the generated signature to the first device. It may also include at least one third device connected to the first device by the data network and including at least the second flow analyzer and the second signature generator and an interface for transmitting the generated signature to the first device.

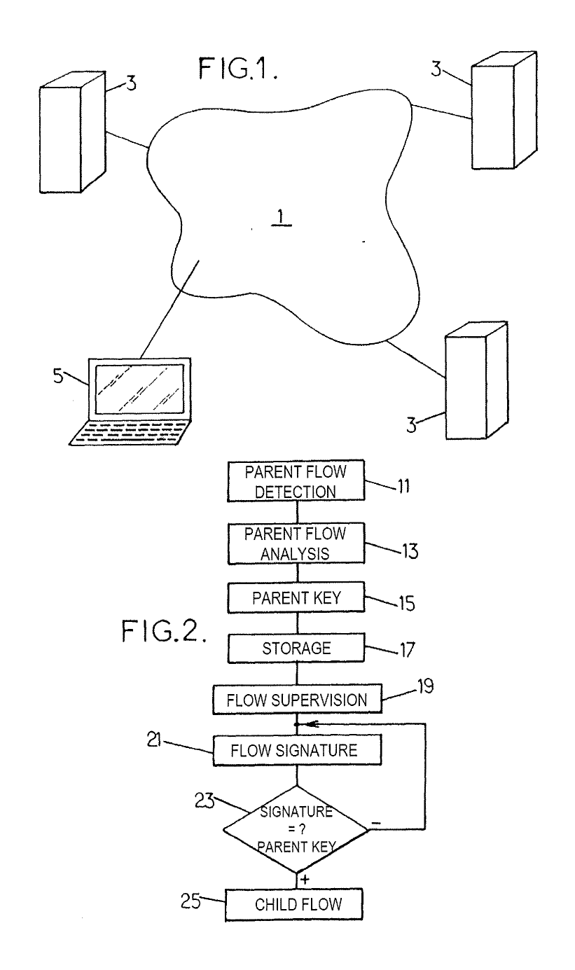

The invention will be better understood by reading the following description provided solely as an example, and by referring to the attached drawings in which:
FIG. 1 is a schematic view of a data network;
FIG. 2 is a flowchart of a method according to one embodiment of the invention;

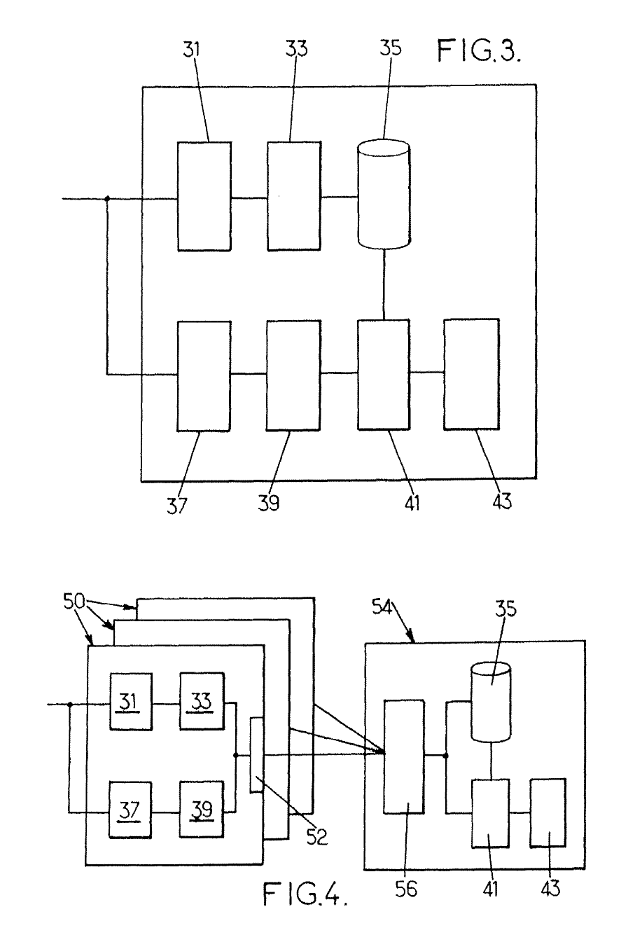

FIG. 3 is a schematic view of a supervision system according to one embodiment of the invention; and

FIG. 4 is a schematic view of a supervision system according to a second embodiment of the invention;

Referring to FIG. 1, a digital data network 1 interconnects multiple devices 3. A supervision system 5 is connected to this network to capture the data flows exchanged between the devices 3.

The system 5 monitors the communication sessions traveling over the network 1. “Session”, or application session, is the set of data exchanges generated by a given network application.

For example, as is well known, when a first device wants to transfer a file to a second device using the FTP protocol, the first device and the second device begin with a first exchange using the TCP protocol on port 21, then agree to transfer the actual file using FTP-DATA which uses the TCP protocol on a port number which varies but is higher than 1024. All of these exchanges together constitute a session.

The first TCP exchange on port 21, and the transfer using FTP-DATA, will be referred to below as sub-sessions, or simply data flows.

The first sub-session will be referred to as the parent sub-session, or parent flow, as it enables the exchange of data between the two devices, which allows establishing the second sub-session which will therefore be called a child sub-session, or child flow.

To monitor a session, the system 5 applies the following method, illustrated in FIG. 2.

By analyzing the transferred data, the system detects in step 11 that an application session has been established in the form of a parent flow.

Then in step 13, the system 5 analyzes the parent flow in search of data to use to establish a child flow. For example, in an FTP session, the system 5 will analyze the sent packets to determine the port number where the file transfer will occur.

Once these data are collected, the system 5 uses these data to generate, in step 15, a signature called the parent key. For example, for an FTP session, the system 5 generates a signature from the IP addresses of the source device and the receiving device and the port number. This signature is, for example, a hash value for these data.

This parent key is stored by the system 5, in step 17.

The system 5 then monitors the flows which could correspond to the child flow, in step 19, for example because they make use of a protocol compatible with it.

For each of these flows, it calculates a signature in step 21. The calculation of this signature is similar to the parent key calculation. For example, for the FTP session, it calculates the hash key for the IP addresses of the two devices and the port number.

This signature is compared to the parent key in step 23.

If the comparison is positive, the corresponding flow is the child flow it is looking for, which is step 25.

For clarity, the following description is limited to one parent flow and one child flow. However, the method is easily generalized to multiple parent flows and child flows.

Thus, if a session consists of a parent flow and multiple child flows, the system calculates as many parent keys as are necessary and it monitors all the flows until all the child flows are found.

Conversely, several sessions, and therefore several parent flows, may be monitored in parallel.

The comparison of the flow signatures is then made for all the parent keys until there is a corresponding parent key, thus defining the related session. If there is no corresponding key, this means that the flow does not belong to any of the monitored sessions.

The method can also be easily applied to sessions comprising multiple levels of inheritance, meaning that a child flow includes data for establishing another flow and behaves as a parent flow for this other flow which is then its child flow. Based on the connection data carried by the child flow, the system defines a parent key to which the signatures of the potential child flows are compared.

The exact implementation of the method may take different forms depending on the technical characteristics desired and the capabilities of the processing system.

For example, the set of parent keys may correspond to a vector of ordered indexes having an attribute which is the session name. Once the signature of a flow is calculated, the search and comparison to the parent key or keys and the assignment of the flow to a session then correspond to an index-based operation, which is a computer operation that is extremely efficient in terms of resources and speed. This also allows pooling the supervision operations for multiple sessions.

The supervision system 5 therefore comprises, as illustrated in FIG. 3:
a first flow analyzer 31 for searching the parent flow for data that allow establishing the child flow;
a first signature generator 33 for generating the signature, referred to as the parent key, using these data;
memory 35 for storing the signature;
a second flow analyzer 37 for auditing data flows using the second protocol on the data network;
a second signature generator 39 for each of these flows;
a comparator 41 for comparing the signature of each of these flows to the parent key; and
a tagger 43 for tagging the flow corresponding to the signature, if the result of the comparator is positive, as the child flow of the session.

This supervision system can be implemented as dedicated electronic circuitry or by specifically programming a computer with a computer program comprising program code stored on a computer-readable medium, which implements the steps of the supervision method when the program is executed on a computer. In particular, this computer includes a network interface which enables it to listen to transmissions over the network, random access memory connected to a processor for generating the keys and signatures, and non-volatile memory which may be, for example, a hard disk drive where the signature creation rules are stored.

One particularly interesting embodiment of this system consists of dividing it into several decentralized devices, FIG. 4. A first series of devices 50 installed in close proximity to the flows includes the flow analyzers 31, 37 and the signature generators 33, 39. Each one then includes a communication interface 52 with a centralized device 54 which includes, in addition to a communicator interface 56 connected to the interfaces 52, the non-volatile memory 35 for storing the signatures, as well as the signature comparator 41 and the tagger 43. This last element may also be found in the first devices 50, in order to tag the flows in proximity to where they are produced.

The invention has been illustrated and described in the drawings and in the above description. Many variant embodiments are possible.

In particular, the supervision system may only comprise a single flow analyzer and a single signature generator, capable of auditing the flows and generating the signatures for both the parent flows and the child flows. Or, in order to increase the speed, there may be as many of them as there are protocol types.

In the claims, the word “comprises” does not exclude other elements and the indefinite article “a” does not exclude a plurality.

1. Method for supervising a communication session over a data network, said session comprising a first data flow, referred to as the parent flow, using a first protocol, said parent flow comprising data which allow establishing a second data flow, referred to as the child flow, using a second protocol for said session, said method comprising:
searching the parent flow for the data that allow establishing the child flow;
generating and storing a signature, referred to as the parent key, using said data;
auditing data flows using the second protocol on said data network;
creating a signature for each of said flows;
comparing said signature of each of said flows to the parent key; and
if the comparison is positive, determining that the corresponding data flow is the child flow of the session.

2. Method according to claim 1, wherein, in the session comprising a determined plurality of child flows, the data flows are audited until the set of child flows is determined.

3. Method according to claim 1, wherein, said child flow comprising data which allow establishing a third data flow using a third protocol for said session, a signature is generated using said data, and data flows using the third protocol are audited until the data flow corresponding to the session is determined.

4. Method according to claim 1, wherein, said method monitoring a plurality of sessions each comprising a parent flow for which a parent key is generated and stored, for each of said flows using the second protocol, the signature is compared to each of the parent keys to determine whether or not said flow is the child flow of one of said sessions.

5. Computer-readable medium having a computer program product stored therein, wherein the computer program product comprises, program code for carrying out a process of supervising a communication session over a data network when said program is executed on a computer, said session comprising a first data flow, referred to as the parent flow, using a first protocol, said parent flow comprising data which allow establishing a second data flow, referred to as the child flow, using a second protocol for said session, the executed process comprising:
searching the parent flow for the data that allow establishing the child flow;
generating and storing a signature, referred to as the parent key, using said data;
auditing data flows using the second protocol on said data network;
creating a signature for each of said flows;
comparing said signature of each of said flows to the parent key; and
if the comparison is positive, determining that the corresponding data flow is the child flow of the session.

6. System for supervising a communication session over a data network, said session comprising a first data flow, referred to as the parent flow, using a first protocol, said parent flow comprising data which allow establishing a second data flow, referred to as the child flow, using a second protocol for said session, said system comprising:
a first flow analyzer for searching the parent flow for data that allow establishing the child flow;
a first signature generator, for generating a signature, referred to as the parent key, using said data;
memory for storing said signature;
a second flow analyzer for auditing data flows using the second protocol on said data network;
a second signature generator for each of said flows;
a comparator for comparing said signature of each of said flows to the parent key; and
a tagger for tagging the flow corresponding to the signature, if the result of the comparator is positive, as the child flow of said session.

7. System according to claim 6, comprising at least two devices connected by a data network, the first device including at least the memory, the signature comparator, and the tagger, and the second device including at least the first flow analyzer and the first signature generator and an interface for transmitting the generated signal to the first device.

8. System according to claim 7, comprising at least a third device connected to the first device by the data network and including at least the second flow analyzer and the second signature generator and an interface for transmitting the generated signature to the first device.
